(19) United States
(12) Patent Application Publication
(10) Pub. No.: US 2008/0157010 A1
(43) Pub. Date: Jul. 3, 2008

(54) Method and Apparatus For Generating Radiation or Particles By Interaction Between a Laser Beam and a Target

(76) Inventors: Michel Bougeard, Limours (FR); Fabien Quere, Velizy Villacoublay (FR); Marina Servol, Montreal (CA)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/661,244

(22) PCT Filed: Aug. 19, 2005
(86) PCT No.: PCT/EP2005/054111

§ 371 Date: Sep. 13, 2007

(30) Foreign Application Priority Data
Aug. 27, 2004 (FR) 0409167

(51) Int. Cl. H05G 2/00

(52) U.S. Cl. 250/503.1

(57) ABSTRACT

To generate radiation or particles by interaction between a laser beam and a target, the selected target is a free flow (5) in a vacuum enclosure (40) of a powder made up of solid grains of size from 10 μm to 1 mm and the laser beam (9), which is an intense pulsed laser beam, is focused onto the powder flow (5) that is driven by gravity only, to create an interaction area (8) generating the radiation or the particles in the vacuum enclosure (40), in which the internal pressure is less than 1000 Pa.

### FIELD OF THE INVENTION

The present invention consists in a method and a device for generating radiation or particles, such as X rays, UV rays, γ rays, ions, or electrons, by interaction between a laser beam and a target.

The interaction of an intense, focused, and pulsed laser beam with a material has been studied in depth. It is now well known that, during such interaction, a plasma is generated at the target and is able to emit various kinds of radiation (such as X rays or UV rays), electrons, or ions. Generating such radiation by means of a laser has many potential applications. UV rays or X rays generated in this way may in particular be used for XUV lithography of integrated circuits. Because of their novel temporal characteristics (in particular their short duration), X rays generated in this way also constitute a source of great interest for medical imaging (hard X rays) and X ray microscopy (soft X rays). As for ions generated by means of a laser, and more particularly protons, their use in proton therapy for cancer is being envisaged.

### PRIOR ART

Many targets have been proposed for interaction with an intense laser beam, in particular to generate X rays or UV rays for applications to XUV lithography of microelectronic components.

One solution proposed in patent document JP9024731 and in patent document JP11345698 consists in using sub-micron size solid particles as the target. It is extremely difficult to obtain a free flow of a powder having particles this size. Because of this, patent documents JP9024731 and JP11345698 propose to use a gas to force the flow of the powder and thus to transport the grains of powder to the area of interaction with the laser.

The above solution is extremely disadvantageous: the gas surrounding the target affects the propagation of the laser beam and, with X rays or UV rays in particular, generally leads to considerable re-absorption of the radiation emitted by the target. Using a pressurized gas also leads to rapid spatial expansion of the jet after leaving the nozzle through which the powder-gas mixture emerges, which leads to a low average volumetric density of material in the area of interaction. Moreover, because of this rapid expansion, it is necessary to place the area of interaction with the laser beam close to the exit nozzle. This is a major disadvantage because it is well known that this kind of configuration generally leads to rapid erosion of the nozzle by the plasma generated by the laser and the production of additional debris linked to that erosion.

### OBJECT AND SUMMARY OF THE INVENTION

The present invention aims to remedy the above-mentioned drawbacks and to enable radiation or particles to be generated without any significant drawback concerning the main characteristics required of the targets used in the context of producing radiation or particles from a plasma produced by a laser.

The present invention aims more particularly to obtain a high local volumetric density, a high mean volumetric density, and a high refresh rate, and all this whilst emitting only a small quantity of debris and without necessitating a gaseous atmosphere.

The invention further aims to provide a source of radiation or particles that has a long service life and that is simple, robust, stable, and highly versatile.

The above objects are achieved by a method of generating radiation or particles by interaction between a laser beam and a target, which method is characterized in that the selected target is a free flow in a vacuum enclosure of a powder made up of solid grains of size from 10 micrometers (μm) to 1 millimeter (mm) and the laser beam, which is an intense pulsed laser beam, is focused onto the powder flow that is driven by gravity only, to create an interaction area generating the radiation or the particles in the vacuum enclosure, in which the internal pressure is less than 1000 pascals (Pa).

The free flow of powder under gravity preferably flows from a feeder funnel that has an inclined wall at an angle α to the horizontal selected as a function of the powder used, and that has in its lower portion an outlet orifice of diameter that determines the diameter of the free flow of powder.

This diameter is advantageously from 0.5 mm to 5 mm. The flow takes place between this feeder device and a lower hopper for recovering powder not destroyed by laser impact.

When operation over a long time period is required, in a preferred use of the invention, the powder is stored in powder feeder means including an upper feeder hopper and means for controlling the flow of the powder above the interaction area. It is then advantageous to place means for recovering residual powder not destroyed by laser impact on the path of the powder downstream of the interaction area with the laser. The powder feeder means and the means for recovering powder that has not been destroyed by the laser beam are preferably identical and interchangeable, although this is not absolutely indispensable.

The powder flowrate is advantageously from 100 cubic centimeters per hour (cm³/h) to 500 cm³/h.

The flow of powder preferably has a diameter from 0.5 mm to 5 mm.

The intense laser beam advantageously consists of pulses with a duration from a few femtoseconds (fs) to a few nanoseconds (ns) and having a peak illumination exceeding 10¹² watts per square centimeter (W/cm²).

The pressure inside the vacuum enclosure is below 1000 Pa and preferably from 0.1 Pa to a few pascals.

The powder may consist of a dielectric solid such as silica.

The powder advantageously comprises spherical grains with a diameter from 1 μm to 45 μm and an average size of the order of 30 μm.

The free flow may be formed from an aerogel powder.

The invention also provides a device for generating radiation or particles by interaction between a laser beam and a target, which device is characterized in that it comprises:
a vacuum enclosure;
a device inside the vacuum enclosure for creating a free flow of powder with solid grains of size from 10 μm to 1 mm;
a laser source for emitting an intense pulsed laser beam; and
focusing means for focusing the intense pulsed laser beam onto an area of interaction with the free flow of powder.

In a preferred embodiment, the device for creating a free flow of powder under gravity comprises a feeder funnel that has a conical wall with an angle α to the horizontal selected as a function of the powder used, and that has in its lower portion an outlet orifice of diameter that determines the diameter of the free flow of powder.

The angle α of the conical wall of the funnel to the horizontal is preferably from 35° to 45°.

The outlet orifice of the conical funnel preferably has a diameter from 0.5 mm to 5 mm.

The powder is advantageously stored in feeder means above the interaction area and including a conical portion whose top is directed downwards and that is followed by a vertical cylindrical portion, and residual powder that has not interacted with the laser beam is advantageously recovered in recovery means below the interaction area.

The feeder means above the interaction area and the recovery means below the interaction area may be identical and interchangeable.

The device of the invention includes powder flow control means able to stop said flow completely, in particular during a preliminary stage of degassing the powder.

In a preferred embodiment, the flow control means are included in the powder feeder means, and identical means are included in the powder receiving means. This embodiment facilitates handling. In this configuration, the connection between the feeder means and the feeder device, consisting for example of a feeder funnel of slope α, is removable, as are the means for transmission to the outside of the vacuum enclosure of control signals for the powder flow control means.

In a variant, there is only one flow control device and it is fixed above the feeder means. In this configuration, a removable bottom is disposed at the lower end of the powder feeder means and the powder receiving means to enable them to be handled and operated as receiving means.

In a preferred embodiment, the first feeder hopper has a conical or pyramidal lower end that is extended by a duct having a section not less than the section of the outlet orifice of the feeder funnel. The flow control means are on this duct, which is of generally cylindrical shape. In a preferred embodiment, the flow control means include a reduction in the section of the duct feeding powder from the feeder means to the feeder funnel. This reduction may terminate at a cylindrical or spherical portion that is rotatable about an axis transverse to the flow and through which passes an orifice of section that corresponds to the required flowrate of the powder towards the feeder funnel. The powder flow control means, which are able to stop said flow completely, may take various forms and, for example, may operate in a manner analogous to a quarter-turn valve employed in the usual on-off mode.

In a particular embodiment, the laser source is outside the vacuum enclosure and the laser beam focusing means take the form of porthole in the wall of the vacuum enclosure.

The device may include transparent protection means between the interaction area and the focusing means to prevent debris damaging said focusing means.

The protection means may comprise a moving strip of transparent material, for example.

The area of interaction between the free flow of powder and the focused laser beam may be situated a few millimeters below the outlet orifice of the funnel or at a greater distance therefrom.

Unlike prior art implementations involving the use of a pressurized gas jet around the target, the present invention achieves a small divergence of the jet of solid grains and a high mean volumetric density, even at great distances from the orifice through which the powder flows. The area of interaction with the focused laser beam can therefore be situated at a relatively great distance from the outlet orifice.

Using a target of the invention has many technical advantages over the prior art.

Consider firstly the criterion of high local volumetric density, which is a necessary characteristic to enable effective absorption of laser energy by the target, and thus a high rate of conversion of that energy into energetic radiation (X, UV, electrons, ions). To be more precise, the local density of the target must typically be of the order of that of a solid or a liquid.

The target of the invention consisting of small solid grains, the local material density is sufficiently high to ensure efficient absorption of the laser energy and consequently high emission of radiation.

The high mean volumetric density criterion is a characteristic that is necessary if a high total flux of radiation is to be obtained. For example, if the target is made up of small dense particles (such as liquid droplets) of size that is very much less than that of the focal spot of the laser, it is essential that the density of the particles be sufficiently high for the focal volume of the laser to contain a large number of particles. If this is not the case, much of the laser energy does not interact with the target and the total flux of radiation obtained is low.

In the invention, the flow being free and effected in particular in the absence of a carrier gas, the distance between the grains in the flow is small and the target therefore has a high mean density. If the focal spot of the laser has a diameter very much greater than the size of the grains, it will contain a large number of grains, which guarantees that a large fraction of the laser beam will interact with the material.

Another criterion takes account of the fact that after each laser firing the target is locally transformed into a plasma by the laser and is therefore destroyed. It is therefore beneficial to move the target or to wait for it to revert to its original structure before the next laser firing. The refresh rate, which is the reciprocal of the time needed, must be as high as possible for the envisaged applications of the invention.

For example, in the invention, it has been established that, at a distance of up to a few millimeters from the powder outlet orifice, the speed at which the grains fall is typically of the order of 10 centimeters per second (cm/s). That speed determines the refresh rate and consequently the maximum laser repetition rate to be used with that particular target. Accordingly, for a laser beam focused onto a 10 μm focal spot, the repetition rate of the laser must not exceed 10 kHz if it is desired that any portion of a solid grain that is irradiated by one laser firing must have left the focal volume by the time of the next laser firing. This repetition rate is convenient for many industrial applications and the invention therefore provides a good solution to the high refresh rate criterion. It may further be noted that the powder flowrate is independent of the quantity of powder remaining in the upper hopper, which constitutes an important property of the device. This is a characteristic inherent to powder flows and has been used to measure time by means of an hourglass, for example.

Another quality criterion is the low quantity of debris emitted. Because the target is destroyed by the laser beam on each firing, debris (ions, hot aggregates of material) is emitted by the target and can become deposited on, and in the long term can damage, instruments surrounding the target (laser optical components, for example). For applications of laser-generated radiation sources, it is essential to minimize the quantity of debris emitted.

In the invention, since the grains are small, little debris is generated by the target. It is found that using this target with various powders, of silica and alumina in particular, does not lead to any significant deposition of material in the experimental enclosure after several hundred hours' operation.

It may also be noted that propagation of the beam in front of the target is affected if the target is surrounded by a relatively dense (≈100 Pa) gaseous medium, which usually degrades the coupling between the laser beam and the target. Moreover, with X rays or UV rays in particular, a gaseous atmosphere around the target generally leads to high re-absorption of the radiation emitted by the target.

In the invention, since the flow is effected with no carrier gas, the laser beam does not suffer any distortion before interacting with the target and the absence of a gaseous atmosphere is advantageous. Moreover, re-absorption of radiation emitted by the laser-generated plasma (and of X rays and UV rays in particular) is very low.

The target service life is the time for which a target can continue to be used without having to be replaced or without requiring intervention by the user. In certain cases, the material flowrate (for example for a jet of liquid) or the cost of the material constituting the target may be important limiting factors.

In the invention, if the size of the orifice in the funnel is 1 mm, for example, the material flowrates measured are of the order of 250 cm³/h. It follows that if powder hoppers having a volume of the order of 10 liters are used, for example, radiation may be generated without interruption for several tens of hours. A device of the invention can therefore very easily include a target that has a very long life. Furthermore, the quantity of powder remaining in the hopper does not influence the flowrate.

The features of simplicity, robustness and stability are crucial in many applications and are decisive in terms of cost and efficiency.

The device of the invention is very simple. It requires no sophisticated or costly hardware, unlike other sources, such as gaseous aggregates, which require major pumping means, or solid filaments, which use sophisticated mechanical stabilization methods. The risks of breakdown are very small. With an appropriate choice of powder, the flows obtained are very stable.

Finally, in a device for generating particles or radiation, the target must be versatile. Thus it is important that the chemical composition of the target can be chosen as freely as possible. With X rays or UV rays, the choice of the composition of the target allows the flux of radiation to be optimized in the spectral range of interest. With ions, that choice determines the nature of the ions obtained.

In the context of the present invention, the target is very flexible to use. Any compound, whether an insulator or a metal, that can be obtained in solid form, can be prepared in the form of a powder and is therefore usable for the purposes of the present invention. Note that the present invention is particularly advantageous with costly solid compounds because all of the powder that has not interacted with the laser beam is recovered and may be re-used directly.

Finally, for certain powders, the divergence of the powder flow is low (less than 1°). This makes it possible to place the point of interaction with the laser beam far from the powder outlet orifice and thereby to avoid any risk of erosion of the feeder device.

In contrast to the subject matter of the present invention, the targets used in prior art devices do not satisfy all of the criteria defined above and have one or more major disadvantages.

### BRIEF DESCRIPTION OF THE DRAWINGS

Other features and advantages of the invention emerge from the following description given with reference to the appended drawings of particular embodiments disclosed by way of example; in the drawings:

FIG. 1 is a diagram of a particular embodiment of a device of the invention;

FIG. 2 is a diagram of an example of a powder feeder funnel usable in the FIG. 1 device;

FIG. 3 is a graph for an example of a device of the invention, plotting the measured speed of the grains of silica microballs within a flow of powder as a function of the distance to the outlet orifice of a powder feeder funnel;

FIG. 4 is a curve representing the lateral position profile of an example of the flow of powder within a device of the invention at a certain distance from the outlet orifice of the powder feeder funnel; and

FIG. 5 represents energy spectra of X rays obtained with two types of silica powder in accordance with the invention and compared with an energy spectrum of X rays obtained with a solid silica target.

### DETAILED DESCRIPTION OF PARTICULAR EMBODIMENTS

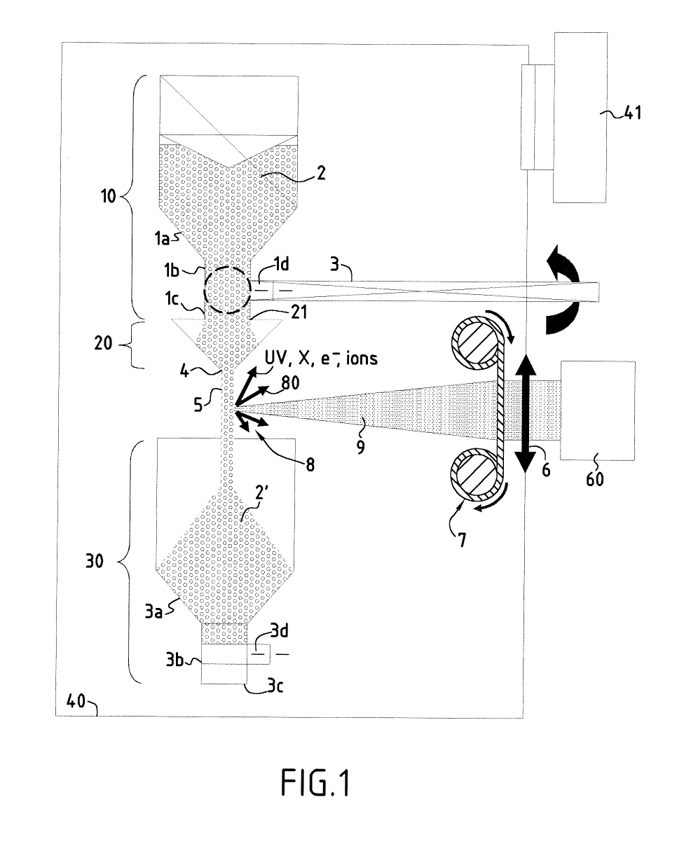

FIG. 1 is a diagram showing a particular embodiment of the invention producing a free flow 5 of solid particles in a vacuum and intended to serve as a target for an intense, focused, and pulsed laser beam in order to generate various types of radiation or to emit particles 80, for example X rays, UV rays, γ rays, electrons, or ions.

An important feature of the invention is the choice of the size of the solid grains constituting the free flow 5 of powder, which must have sizes from 10 μm to 1 mm.

The powder 2 is initially contained in feeder means 10 consisting of a hopper 1a with a conical bottom extended by a duct 1b. Its flow is controlled by a control device consisting of a valve 1d removably connected to a rotary drive rod 13. This valve is closed while filling the powder hopper or while degassing the powder when establishing the vacuum. It is open in operation, and the powder then flows freely under gravity into powder recovery means 30, which are identical to the powder feeder means 10 and interchangeable therewith. Once it has reached the bottom of the feeder means 10, the powder escapes to the feeder device, consisting of a feeder funnel 20, which is generally conical, and then through an orifice 4 at its bottom to the vacuum enclosure, in which it therefore forms a continuous flow 5. There is obtained in this way a cylindrical volume containing a high density of solid grains. A laser beam 9 is focused on this flow. The solid grains absorb a portion of the laser energy and return it in the form of radiation 80. The type of radiation obtained and its energy range depend on the nature of the powder selected and on the characteristics of the laser beam. Powder that has not interacted with the laser is collected in the recovery means 30. The whole of the device is placed in an enclosure 40 within which the pressure is sufficiently low for the propagation of the laser beam 9 not to be degraded by residual gas and for the radiation 80 emitted by the plasma (in particular X rays and UV rays) not to be re-absorbed over very short distances. To obtain a satisfactory flow of powder (high mean density, low divergence), it is essential to minimize the pressure difference between the interior of the feeder means 10 and the vacuum enclosure 40. In particular this requires thorough purging of the powder to remove any gas initially trapped in the powder, by pumping for a sufficiently long time.

FIG. 1 shows a particular embodiment in which feeder means 10 and recovery means 30 that are removable and interchangeable are used in the vacuum enclosure 40 associated with a pumping device 41.

The feeder means 10 contain the powder 2 to provide the target. The lower portion of the hopper 1a has a conical shape extended by a straight cylindrical portion 1b provided with control means consisting of a valve 1d for establishing or interrupting the flow of powder. The valve 1d may comprise a simple rotary mechanism, for example, like a quarter-turn valve.

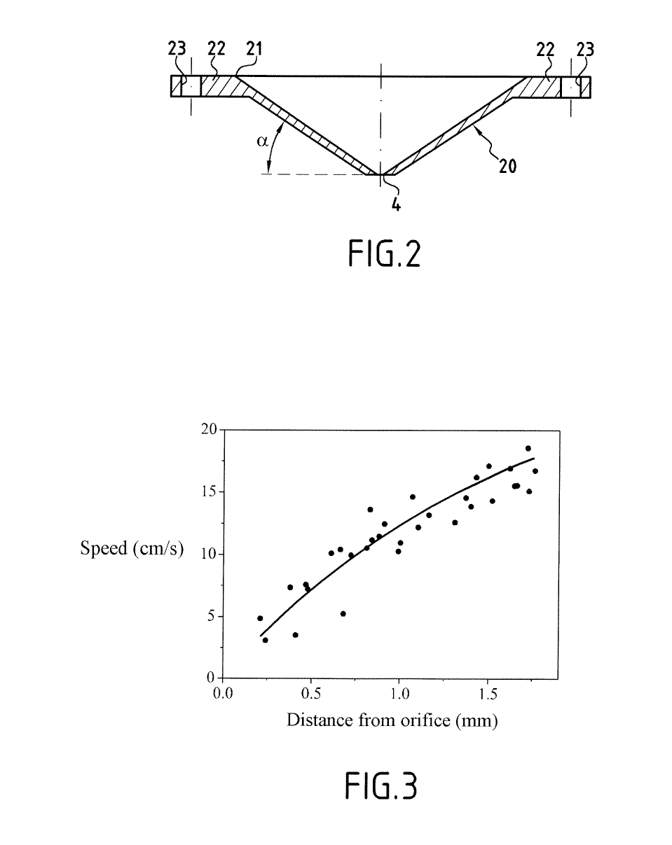

The cylindrical portion terminates at an outlet 1c to which are connected the feeder means using a conical feeder funnel 20 receiving the powder via its inlet 21 and having an orifice 4 at its other end. The slope angle α to the horizontal of the conical surface (FIG. 2) is selected to enable good flow of the powder and therefore depends on the powder used.

This angle may be determined experimentally in the following manner: the powder is spread out flat on the bottom of a container, which is then progressively inclined to the horizontal. At a certain angle between the surface of the powder and the horizontal, the powder suddenly flows, forming an avalanche. The angle at which this avalanche begins is the start of avalanche angle. Just after the avalanche, the powder surface forms a non-zero angle to the horizontal. That angle is the end of avalanche angle. An angle α for the cone of the feeder funnel 20 that lies between the start of avalanche angle and the end of avalanche angle is generally the optimum for the flow of the powder in question. This angle is generally from 30° to 45°.

The diameter of the orifice 4 at the bottom of the feeder funnel must be large enough to allow a good flow of the powder. Its minimum value depends on the powder used. Neither must the diameter of the orifice be too large, in order to limit the flowrate of material through the orifice and thus to optimize the duration of operation of the target. This diameter is typically from 0.5 mm to 5 mm.

The flowrate of material through the orifice 4 may be from 100 cm³/hour to 500 cm³/hour, for example.

The feeder funnel 20 may have an upper face defining an upper flange 22 provided with connecting means 23 to receive the lower portion 1b, 1c of the upper hopper 10.

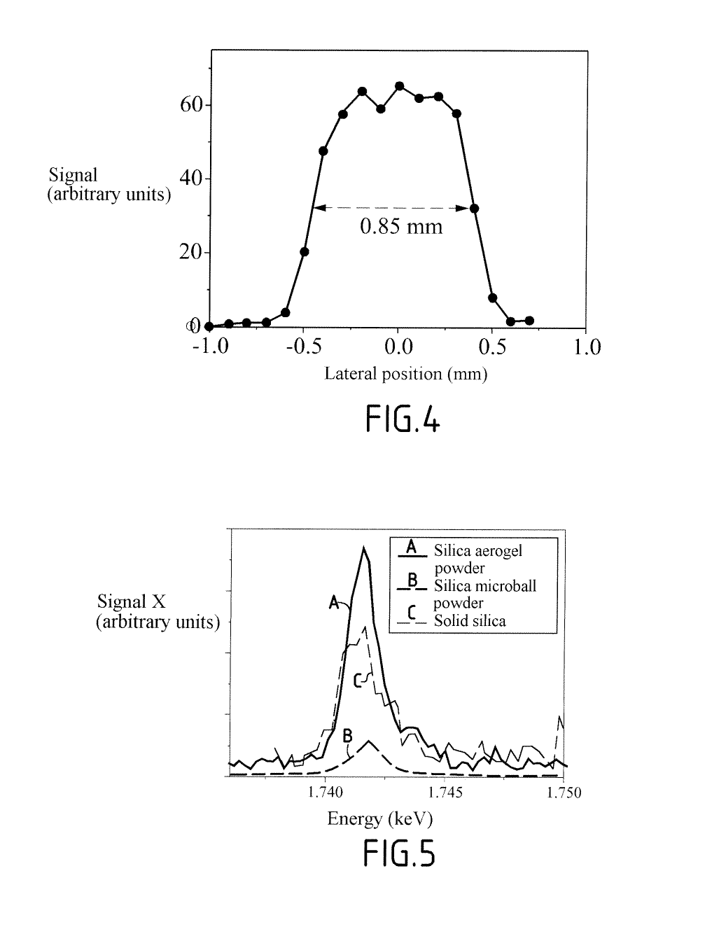

The powder flows freely in this system under gravity. To obtain a satisfactory flow, the size of the grains must be at least 10 μm. Their size can be up to 1 mm if a sufficiently large orifice is used. The grain shape is also important: spherical grains generally provide a flow of very good quality, but this solution is not absolutely necessary. A flow 5 of cylindrical shape is obtained (FIG. 4). The diameter of this flow is of the order of the diameter of the powder exit orifice 4 (FIG. 4). For certain powders, it may remain at this order of magnitude over a distance of around ten centimeters.

FIG. 3 shows the measured speed in cm/s of the grains of a powder made up of silica microballs with a mean diameter of 30 μm as a function of the distance to the outlet orifice 4 of the feeder funnel 20 expressed in millimeters.

FIG. 4 shows the lateral position profile of a flow 5 of the same microball powder at a distance of 1 cm from the outlet orifice 4 of the feeder funnel 20, which in this example has a diameter of 0.9 mm. This curve was obtained by measuring the total flux of X radiation generated by an intense femtosecond pulsed laser beam 9 focused with a diameter of 15 μm onto the flow 5 as a function of the lateral position of the focal spot.

It is seen that the flow 5 remains generally cylindrical with a diameter of the order of 0.85 mm.

The intense laser beam, consisting of pulses with a duration from a few femtoseconds to a few nanoseconds, is focused on the flow 5 by means known in the art (for example a lens 6 as shown in FIG. 1 or a focusing mirror). Depending on the size of the focal spot of the laser, the laser energy is absorbed by one or more solid grains, at the surface whereof a plasma is generated. Depending on the characteristics (energy, pulse duration, focusing, wavelength) of the laser beam emitted by a laser source 60 outside the vacuum enclosure 40 and on the composition of the powder used, the plasma may emit different types of radiation (in particular X rays or UV rays), electrons, or ions.

The flowing powder (2′) is collected in the powder recovery means 30. In this particular embodiment the recovery means 30 are identical to the feeder means 10 with a frustoconical lower portion 3a extended by a vertical cylindrical portion 3b and an outlet 3c that is blocked by a valve 3d when in the closed position.

Once the upper hopper is empty, it suffices to interchange the powder feeder means 10 and the powder recovery means 30 to render the target operational again. Other systems for renewing the powder 2 in the upper hopper and recovering powder in the lower hopper may naturally be used without departing from the scope of the present invention.

In a variant, an upper hopper constituting the feeder means 10 has an open lower end that can be connected to the means for controlling the flow of powder comprising at least the downstream portion of the cylindrical section 1b equipped with the valve 1d and terminating at the opening 1c. In this case, there is only one powder flow control device, fixed to the feeder means 20. A simple removable bottom may be attached to the lower portion of the hopper when said hopper is in the lower hopper 30 position and serving as the powder recovery means, without the valve 3d. The upper hopper 10 and the lower hopper 30 are then identical and interchangeable, but there is only one powder flow control device comprising the valve 1d fixed to the powder feeder device 20.

The powder feeder device is based on the use of a conical feeder funnel having a slope α to the horizontal and an evacuation orifice.

The whole of the above system operates in a vacuum enclosure 40 in order not to degrade the propagation of the intense laser beam 9. This also produces flows of better quality, in particular in terms of stability. A primary vacuum (a pressure of the order of 0.1 Pa to a few Pascals) is sufficient. The optical system used for focusing the laser beam may be inside or outside the vacuum enclosure 40 or, with a lens 6, it serve as a porthole in the wall of the enclosure 40, as in the situation represented in FIG. 1.

Various protection devices may be installed to protect the various components of the assembly, such as the optical system 6 for focusing the laser beam or an optical system for collecting the X rays, from debris generated by the interaction between the laser beam and the powder. For example, a system with a moving transparent strip 7 may be used, or a localized flow of gas between the area 8 of interaction between the laser beam and the powder and the component to be protected.

The powders used may be of different kinds. Solid dielectric (such as silica) powders are particularly suitable. For example, a silica powder consisting of spherical grains with a diameter from 1 μm to 45 μm (mean diameter 30 μm) produces a very stable flow using a feeder funnel angle α=40° and an orifice 4 of 1 mm diameter.

The nature of the powder used and the laser parameters are determined by the characteristics of the radiation or the type of particle to be obtained. For example, using intense femtosecond pulses (peak illumination≈a few 10¹⁶ W/cm²) having low temporal contrast (10⁻⁵ on the nanosecond scale) obtains a high flux of energetic electrons, as is well known to persons skilled in the art of solid targets. The term “temporal contrast” refers to the ratio between the residual luminous power preceding the pulse and the peak luminous power.

For example, X rays have been measured in the keV range (silicon lines K_{α} to He_{α}) by means of a Bragg diffraction X ray spectrometer using two types of silica powder irradiated by laser pulses with a duration of 40 femtoseconds and a peak illumination of the order of 5.10¹⁶ W/cm². These spectra (curves A and B) are shown in FIG. 5, where they are compared to a spectrum (curve C) obtained for identical laser parameters and exactly the same accumulation time with a solid silica target for a polarization p of the laser beam and an angle of incidence of 45°. It can be seen that the flux of X photons corresponding to the silicon line K_{α} is slightly higher when a silica aerogel powder is used (curve A) than when a solid target is used (curve C) and slightly lower with a powder made up of silica microballs (curve B). Note therefore the particular benefit of aerogel powders (for example silica aerogels), which are very porous materials, for which the coupling with the laser is very efficient.

To obtain UV radiation, a flow of powder may be irradiated with energetic nanosecond laser pulses. The chemical composition of the powder selected may optimize the flux of UV radiation in a particular spectral range.

One important aspect of the present invention is that the powder flows freely, i.e. the flow is induced merely by gravity, without there being any jet of gas around the flow.

1. A method of generating radiation or particles by interaction between a laser beam and a target, which method is characterized in that the selected target is a free flow in a vacuum enclosure of a powder made up of solid grains of size from 10 μm to 1 mm and the laser beam, which is an intense pulsed laser beam, is focused onto the powder flow that is driven by gravity only, to create an interaction area generating the radiation or the particles in the vacuum enclosure, in which the internal pressure is less than 1000 Pa.

2. A method according to claim 1, characterized in that the internal pressure in the vacuum enclosure is from 0.1 Pa to a few Pascals.

3. A method according to claim 1, characterized in that the free flow of powder under gravity flows from a feeder funnel that has an inclined wall at an angle α to the horizontal selected as a function of the powder used, and that has in its lower portion an outlet orifice of diameter that determines the diameter of the free flow of powder.

4. A method according to claim 3, characterized in that the angle α is from 30° to 45° and the outlet orifice has a diameter from 0.5 mm to 5 mm.

5. A method according to claim 1, characterized in that the powder is stored in feeder means above the interaction area and residual powder that has not interacted with the laser beam is recovered in recovery means below the interaction area.

6. A method according to claim 5, characterized in that the powder feeder means and the means for recovering powder that has not been destroyed by the laser beam are identical and interchangeable.

7. A method according to claim 1, characterized in that the flowrate of the powder in the flow is from 100 cm³/hour to 500 cm³/hour.

8. A method according to claim 1, characterized in that the intense laser beam comprises pulses having a duration from a few femtoseconds to a few nanoseconds and a peak illumination exceeding 10¹² W/cm².

9. A method according claim 1, characterized in that the powder is made up of a dielectric solid such as silica.

10. A method according to claim 1, characterized in that the powder comprises spherical grains having a diameter from 1 μm to 45 μm and a mean diameter of the order of 30 μm.

11. A method according to claim 1, characterized in that the free flow is formed from an aerogel powder.

12. An application of the method according to claim 1 to the production of X rays, UV rays, γ rays, electrons, or ions.

13. A device for generating radiation or particles by interaction between a laser beam and a target, which device is characterized in that it comprises:
a vacuum enclosure;
a device inside the vacuum enclosure for creating a free flow of powder with solid grains of size from 10 μm to 1 mm;
a laser source for emitting an intense pulsed laser beam; and
focusing means for focusing the intense pulsed laser beam onto an area of interaction with the free flow of powder.

14. A device according to claim 13, characterized in that the device for creating a free flow of powder under gravity comprises a feeder funnel that has a conical wall with an angle α to the horizontal selected as a function of the powder used, and that has in its lower portion an outlet orifice of diameter that determines the diameter of the free flow of powder.

15. A device according to claim 14, characterized in that the angle α is from 30° to 45° and the outlet orifice of the conical funnel has a diameter from 0.5 mm to 5 mm.

16. A device according to claim 13, characterized in that the powder is stored in feeder means above the interaction area and including a conical portion whose top is directed downwards and that is followed by a vertical cylindrical portion, and residual powder that has not interacted with the laser beam is recovered in recovery means below the interaction area.

17. A device according to claim 16, characterized in that the feeder means above the interaction area and the recovery means below the interaction area are identical and interchangeable.

18. A device according to claim 13, characterized in that it includes means for controlling the flow of powder able to stop the flow of powder completely.

19. A device according to claim 27, characterized in that the connection between the feeder means and the feeder funnel is removable.

20. A device according to claim 18, characterized in that the laser source is outside the vacuum enclosure and the means for focusing the laser beam take the form of a porthole in the wall of the vacuum enclosure.

21. A device according to claim 20, characterized in that it further comprises transparent protection means between the interaction area and the focusing means.

22. A device according to claim 21, characterized in that the protection means comprise a moving strip of transparent material.

23. A device according to claim 13, characterized in that the pressure inside the vacuum enclosure is from 0.1 Pa to a few pascals.

24. A device according to claim 14, characterized in that the area of interaction between the free flow of powder and the focused laser beam is a few millimeters below the outlet orifice of the funnel.

25. A method according to claim 2, characterized in that:
the free flow of powder under gravity flows from a feeder funnel that has an inclined wall at an angle α to the horizontal selected as a function of the powder used, and that has in its lower portion an outlet orifice of diameter that determines the diameter of the free flow of powder;
the angle α is from 30° to 45° and the outlet orifice has a diameter from 0.5 mm to 5 mm;
the powder is stored in feeder means above the interaction area and residual powder that has not interacted with the laser beam is recovered in recovery means below the interaction area;
the powder feeder means and the means for recovering powder that has not been destroyed by the laser beam are identical and interchangeable;
the flowrate of the powder in the flow is from 100 cm³/hour to 500 cm³/hour;
the intense laser beam comprises pulses having a duration from a few femtoseconds to a few nanoseconds and a peak illumination exceeding 10¹² W/cm²;
the powder is made up of a dielectric solid such as silica;
the powder comprises spherical grains having a diameter from 1 μm to 45 μm and a mean diameter of the order of 30 μm;
the free flow is formed from an aerogel powder.

26. An application of the method according to claim 25 to the production of X rays, UV rays, γ rays, electrons, or ions.

27. A device according to claim 15, characterized in that:
the powder is stored in feeder means above the interaction area and including a conical portion whose top is directed downwards and that is followed by a vertical cylindrical portion, and residual powder that has not interacted with the laser beam is recovered in recovery means below the interaction area;
the feeder means above the interaction area and the recovery means below the interaction area are identical and interchangeable;
it includes means for controlling the flow of powder able to stop the flow of powder completely.

28. A device according to claim 27, characterized in that:
the laser source is outside the vacuum enclosure and the means for focusing the laser beam take the form of a porthole in the wall of the vacuum enclosure;
it further comprises transparent protection means between the interaction area and the focusing means.

29. A device according to claim 27, characterized in that the pressure inside the vacuum enclosure is from 0.1 Pa to a few pascals.

30. A device according to claim 28, characterized in that the pressure inside the vacuum enclosure is from 0.1 Pa to a few pascals.
